(19) United States
(12) Patent Application Publication
(10) Pub. No.: US 2025/0123151 A1
(43) Pub. Date: Apr. 17, 2025

(54) METHOD AND CIRCUIT ARRANGEMENT FOR ASCERTAINING A JUNCTION TEMPERATURE OF A SEMICONDUCTOR COMPONENT COMPRISING AN INSULATED GATE

(71) Applicant: Robert Bosch GmbH, Stuttgart (DE)

(72) Inventors: Karl Oberdieck, Neckartenzlingen (DE); Manuel Riefer, Reutlingen (DE); Sebastian Strache, Wannweil (DE); Stephan Schwaiger, Bodelshausen (DE)

(21) Appl. No.: 18/682,068

(22) PCT Filed: Sep. 19, 2022
(86) PCT No.: PCT/EP2022/075895

§ 371 Date: Feb. 7, 2024

(30) Foreign Application Priority Data
Sep. 27, 2021 (DE) 10 2021 210 712.5

(51) Int. Cl. G01K 7/01

(52) U.S. Cl. CPC G01K 7/01; G01K 2217/00

(57) ABSTRACT

A method and a circuit arrangement for ascertaining a junction temperature of a semiconductor component including an insulated gate. The method includes: recharging an input capacitance of the semiconductor component using a current-controlled gate driver at a predefined first time, and ascertaining a junction temperature of the semiconductor component based on information about a voltage-dependent behavior of the input capacitance of the semiconductor component and based on a level of an internal gate resistor of the semiconductor component at a second time which follows the first time, at which a current build-up phase of a gate current generated by the gate driver for recharging the input capacitance has ended and at which a substantially constant gate current is present.

### FIELD

The present invention relates to a method and circuit arrangement for ascertaining a junction temperature of a semiconductor component comprising an insulated gate.

### BACKGROUND INFORMATION

The junction temperature of power semiconductors is an important state variable for measuring instantaneous semiconductor loads. In the development process of unpackaged and packaged semiconductors in single-chip or multi-chip arrangements, appropriate temperature limits (currently often 175° C. or 200° C. for a limited number of hours, depending on the semiconductor technology and the manufacturer) are enabled. A component or system designer who uses these semiconductors (modules) has to therefore take these temperature limits into account and uphold design margins derived from parameter scatter. To reduce the design margins and thus save unit costs, attempts are made to acquire the temperature via additional sensors such as NTC resistors and/or to estimate the temperature as accurately as possible via temperature-sensitive electrical parameters (TSEP).

Also from the related art is actuating a gate of such power semiconductors by means of a voltage-controlled or current-controlled gate driver.

### SUMMARY

According to a first aspect of the present invention, a method for ascertaining a junction temperature of semiconductor component comprising an insulated gate is provided. The semiconductor component is a Si MOSFET, a SiC MOSFET, an IGBT, an HEMT or an otherwise configured semiconductor component, for example.

In a first step of the method according to an example embodiment of the present invention, an input capacitance of the semiconductor component is recharged by means of a current-controlled gate driver at a predefined first time.

In a second step of the method according to an example embodiment of the present invention, a junction temperature of the semiconductor component is ascertained on the basis of information about a voltage-dependent behavior of the input capacitance of the semiconductor component and on the basis of a level of an internal temperature-dependent gate resistor of the semiconductor component at a second time which follows the first time, wherein, wherein a current build-up phase of a gate current generated by the gate driver for recharging the input capacitance has ended at the second time, and wherein a substantially constant gate current is present at the second time.

In other words, the temperature dependence of the gate resistor is used to derive the current junction temperature of the semiconductor component from a currently ascertained level of the internal gate resistor. The temperature dependence of the internal gate resistor and the voltage dependence of the input capacitance of the semiconductor component are stored in a memory unit, for instance in the form of characteristic maps, and can be retrieved from said memory unit for the method according to the present invention.

Among other things, the method according to the present invention has an advantage that the junction temperature of the semiconductor component can be ascertained with a high degree of reliability, irrespective of a respective load current and/or a respective operating temperature and/or a respective intermediate circuit voltage.

Preferred further developments of the present invention are disclosed herein.

In an advantageous embodiment of the present invention, the second time is a predefined time that reliably ensures that the current build-up phase of the gate current of the semiconductor component has always ended when the second time is reached, regardless of the respective existing boundary conditions. The level of the internal gate resistor of the semiconductor component is accordingly ascertained on the basis of an external gate voltage present at the second time and a constant gate current present at the second time.

In a further advantageous embodiment of the present invention, the second time is reached when the external gate voltage reaches a predefined threshold value. The level of the internal gate resistor is ascertained on the basis of a time difference between the second time and the first time. For this purpose, it is necessary that the substantially constant gate current has an identical current value between respective ascertainment procedures of the junction temperature, or that information about the level of the respective gate current is available. Ascertaining the junction temperature on the basis of the here-described time difference between the second time and the first time has the advantage that there is no need to implement a voltage measurement at a predefined time, which, for example when realized by means of an integrated circuit, can be laborious to implement. It is thus also possible to increase accuracy when ascertaining the junction temperature. The threshold value is preferably set such that it is ensured that the current build-up phase of the gate current has always ended when the threshold value is reached by the external gate voltage, regardless of the respective existing boundary conditions.

The method according to an example embodiment of the present invention particularly advantageously comprises a calibration procedure during which deviations of temperature-related parameters of the semiconductor component from respective target values are ascertained. This is done on the basis of an additional temperature measurement by means of a temperature sensor, such as an NTC, for instance, which is disposed inside and/or outside a semiconductor module containing the semiconductor component, for example. Alternatively or additionally, it is also possible to carry out the calibration on the basis of a cooling water temperature measurement, a printed circuit board temperature measurement, etc., which are in thermal contact with the semiconductor component. Following the ascertainment of the temperature of the semiconductor component on the basis of the additional temperature measurement, compensation values are ascertained to then compensate deviations of the temperature-related parameters from the respective target values. This makes it possible to improve accuracy when ascertaining the junction temperature of the semiconductor component. The calibration procedure takes place during production of the semiconductor component and/or a component containing the semiconductor component, for example.

Preferably, according to an example embodiment of the present invention, the results of a plurality of temporally successive calibration procedures are stored, so that a degradation state of the semiconductor component can be ascertained on the basis of deviations between respective stored results of the calibration procedures.

The calibration procedure according to an example embodiment of the present invention preferably provides ascertaining a temperature coefficient for the semiconductor component on the basis of at least two measurements which differ from one another in term of time and/or ascertaining a temperature dependence of the gate driver in order to then take into account the temperature coefficient and/or information about the temperature dependence of the gate driver when ascertaining the junction temperature. This makes it possible to improve accuracy when ascertaining the junction temperature of the semiconductor component.

Ascertaining the junction temperature is advantageously carried out during a switching-on process and/or a switching-off process of the semiconductor component of which the required recharging of the gate capacitance is an inherent part. Alternatively or additionally, ascertaining the junction temperature is carried out in a switched-on and/or a switched-off state of the semiconductor component, wherein a predefined alternating signal, in particular a pulse-shaped alternating signal (without being restricted to such a form of the signal; sinusoidal or other types of alternating signals can be used as well, for example) is generated by the gate driver at the gate of the semiconductor component. The use of a pulse in the context of the current-controlled gate driver according to the present invention is particularly advantageous, because such a signal shape is particularly easy to generate by means of the current-controlled gate driver. A frequency and/or an amplitude of the alternating signal is preferably selected such that the function of a load actuated by means of the semiconductor component is not or only insignificantly influenced as a result.

When ascertaining the junction temperature, an influence of an amount of charge that is recharged during the current build-up phase with respect to the input capacitance of the semiconductor component is particularly advantageously taken into account as well. This makes it possible to further increase accuracy when ascertaining the junction temperature of the semiconductor component.

According to a second aspect of the present invention, a circuit arrangement for ascertaining a junction temperature of a semiconductor component is provided. According to an example embodiment of the present invention, the circuit arrangement comprises: a semiconductor component comprising an insulated gate, a current-controlled gate driver, a voltage measuring unit and an evaluation unit. The current-controlled gate driver is configured to recharge an input capacitance of the semiconductor component at a first predefined time via an actuation of the gate of the semiconductor component. The voltage measuring unit is configured to acquire an external gate voltage of the semiconductor component. The evaluation unit, which is embodied as an ASIC, FPGA, processor, digital signal processor, microcontroller or the like, for example, and is a component of the current-controlled gate driver, for instance, or a standalone component of the circuit arrangement, is configured to ascertain a junction temperature of the semiconductor component on the basis of information about a voltage-dependent behavior of the input capacitance of the semiconductor component and on the basis of a level of an internal gate resistor of the semiconductor component at a second time which follows the first time, at which a current build-up phase of a gate current generated by the gate driver for recharging the input capacitance has ended and at which a substantially constant gate current is present. The features, feature combinations and the advantages resulting therefrom correspond to those described in connection with the first-mentioned aspect of the present invention so clearly that, to avoid repetition, reference is made to the above descriptions.

In a particularly advantageous embodiment of the present invention, the internal gate resistor of the semiconductor component comprises a bidirectionally conductive, non-linear component, which is in particular configured of two diodes connected in antiparallel. The pronounced temperature dependence of diodes makes it possible to achieve a particularly high sensitivity and thus a particularly accurate temperature determination using the circuit arrangement according to the present invention. It should be noted that non-linear components or components that differ from the diodes described here can also be used. Due to its non-linear current properties, the diode also makes it possible to limit the value of a voltage difference between the external and the internal gate voltage, as a result of which a particularly high immunity to interference is achieved in such a circuit arrangement. One of the reasons for this is that gate overvoltages caused by coupling can be intercepted more easily, as a result of which a higher short-circuit resistance can be achieved, for instance, in particular in the context of a type 2 short circuit. The two diodes connected in antiparallel are configured between a gate pad and a gate runner of the semiconductor component, for example.

### BRIEF DESCRIPTION OF THE DRAWINGS

Embodiment examples of the present invention are described in detail in the following with reference to the figures.

FIG. 1 shows an example embodiment of a circuit arrangement according to the present invention.

FIG. 2 shows an ascertainment of a current junction temperature of a semiconductor component on the basis of a gate voltage measurement at a predefined second time.

FIG. 3 shows an example of a gate current profile.

FIG. 4 shows an ascertainment of a current junction temperature of a semiconductor component on the basis of a time measurement.

FIG. 5 shows a semiconductor component according to an example embodiment of the present invention having a non-linear internal gate resistor.

### DETAILED DESCRIPTION OF EXAMPLE EMBODIMENTS

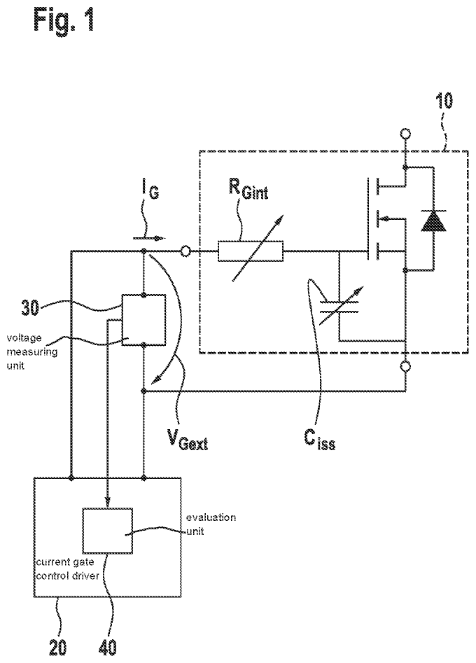

FIG. 1 shows an embodiment of a circuit arrangement according to the present invention. The circuit arrangement comprises a SiC MOSFET 10, which has a temperature-dependent linear internal gate resistor R_{Gint} and a voltage-dependent input capacitance Cᵢₛₛ.

A gate of the SiC MOSFET 10 is actuated by means of a current-controlled gate driver 20, which includes an evaluation unit 40. Both components are integrated into an ASIC here.

A voltage measuring unit 30 is connected between a gate terminal and a source terminal of the SiC MOSFET 10 and is thus configured to acquire an external gate voltage V_{Gext} of the SiC MOSFET 10.

Based on the above configuration, the current-controlled gate driver 20 is configured to recharge the input capacitance Cᵢₛₛ of the SiC MOSFET 10 via an actuation of the gate of the SiC MOSFET 10 at a first predefined time T1, which here corresponds to a switch-on time of the SiC MOSFET 10.

The evaluation unit 40 is ultimately configured to ascertain a junction temperature of the SiC MOSFET 10 on the basis of information about a voltage-dependent behavior of the input capacitance Cᵢₛₛ of the SiC MOSFET 10 and on the basis of a level of a temperature-dependent internal gate resistor R_{Gint} at a second time T2 which follows the first time T1, at which a current build-up phase PA of a gate current I_{G} generated by the gate driver 20 for recharging the input capacitance Cᵢₛₛ has ended and at which a substantially constant gate current I_{G} is present.

When ascertaining the junction temperature, compensation values for temperature-related parameters of the SiC MOSFET 10 ascertained during a previous calibration procedure are preferably taken into account. Carrying out such a calibration several times and comparing respective calibration results also makes it possible to ascertain any existing degradation of the SiC MOSFET 10.

Temperature-dependent properties of the gate driver 20 are further preferably taken into account as well when ascertaining the junction temperature in order to increase the accuracy of the ascertainment even more.

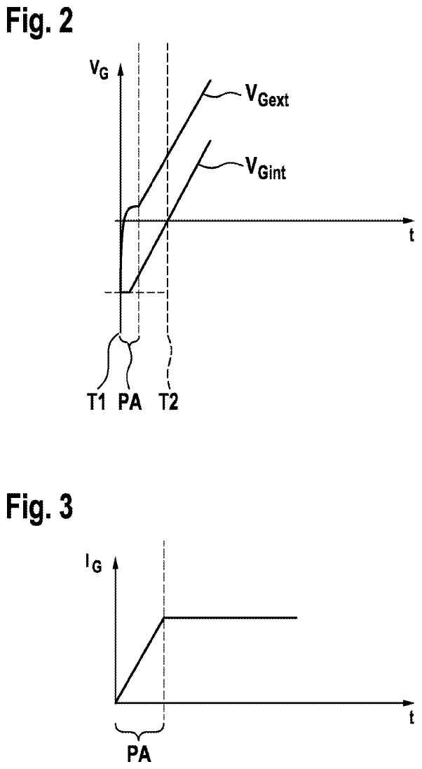

FIG. 2 shows an ascertainment of a current junction temperature of a semiconductor component 10 on the basis of a gate voltage measurement at a predefined second time T2 during a switching-on process of the semiconductor component 10, wherein the switching-on process is started at a time T1. Based on the circuit arrangement described in FIG. 1, an external gate voltage V_{Gext} of the semiconductor component 10 is measured by means of a voltage measuring unit 30 at the second time T2, which is chronologically after a current build-up phase PA. From this, an internal gate voltage V_{Gint} of the semiconductor component 10 is derived to ascertain a current junction temperature of the semiconductor component 10 on the basis of the internal gate voltage V_{Gint} and on the basis of a gate current I_{G} present at the second time T2.

FIG. 3 shows an example progression of a gate current I_{G}. The figure in particular shows a current build-up phase PA, which occurs as a target gate current is built up by a current-controlled gate driver 20. Once the current build-up phase PA has ended, the current-controlled gate driver 20 provides a substantially constant gate current I_{G}.

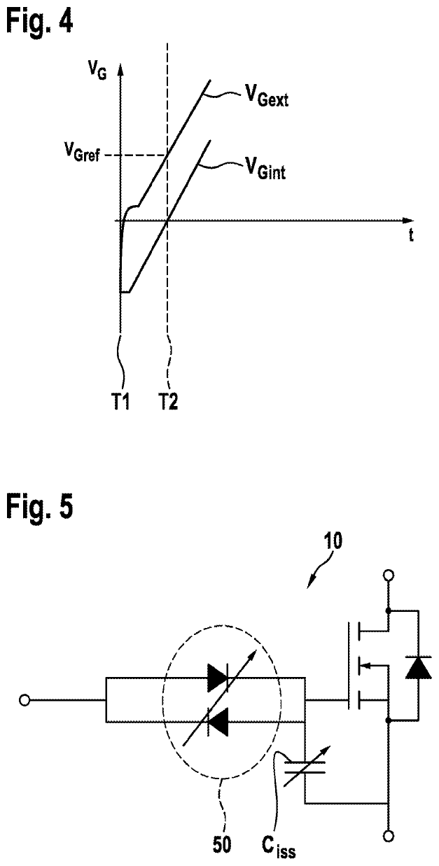

FIG. 4 shows an ascertainment of a current junction temperature of a semiconductor component 10 based on a time measurement. Specifically, a time difference between a second time T2 and a first time T1, which represents a start of a gate current variation by means of a predefined pulse, is used here to ascertain a junction temperature of the semiconductor component 10. The second time T2 is then reached when the external gate voltage V_{Gext} reaches a predefined threshold value V_{Gref}. This is preferably ascertained using a comparator, which compares the two voltages. This also takes into account an amount of charge which is introduced into an input capacitance Cᵢₛₛ of the semiconductor component 10 during a current build-up phase PA in order to enable a more precise determination of the junction temperature of the semiconductor component 10.

FIG. 5 shows a semiconductor component according to the present invention, which is configured as a MOSFET 10, with a non-linear internal gate resistor R_{Gint}, which is composed here of two diodes connected in antiparallel 50 in order to achieve a particularly high temperature sensitivity for ascertaining a junction temperature of the MOSFET 10. To produce a MOSFET 10 that is configured in this manner, a MOSFET process according to the related art is used, for instance. Instead of establishing direct electrical contact between a gate pad and a gate electrode of the MOSFET 10, a bidirectional diode 50, for example consisting of two differently doped semiconductor layers (p-doped and n-doped silicon), is disposed here between the gate pad and the gate electrode. The two diodes 50 are deposited and structured in two successive manufacturing steps, for example, so that they have electrical contact to one another, to the gate pad and to the gate electrode at predefined positions.

1-10. (canceled)

11. A method for ascertaining a junction temperature of a semiconductor component including an insulated gate, the method comprising the following steps:
recharging an input capacitance of the semiconductor component using a current-controlled gate driver at a predefined first time; and
ascertaining a junction temperature of the semiconductor component based on information about a voltage-dependent behavior of the input capacitance of the semiconductor component and based on a level of an internal gate resistor of the semiconductor component at a second time which follows the first time, the second time being a time at which a current build-up phase of a gate current generated by the gate driver for recharging the input capacitance has ended and at which a substantially constant gate current is present.

12. The method according to claim 11, wherein:
the second time is a predefined time, and
the level of the internal gate resistor of the semiconductor component is ascertained based on an external gate voltage present at the second time and a gate current present at the second time.

13. The method according to claim 12, wherein:
the second time is reached when the external gate voltage reaches a predefined threshold value, and
the level of the internal gate resistor is ascertained based on a time difference between the second time and the first time.

14. The method according to claim 11, further comprising a calibration procedure comprising:
ascertaining deviations of temperature-related parameters of the semiconductor component from respective target values, including based on an additional temperature measurement by a temperature sensor,
ascertaining compensation values for compensating for the deviations of the temperature-related parameters from respective target values.

15. The method according to claim 14, further comprising:
storing results of a plurality of temporally successive calibration procedures, and
ascertaining a degradation state of the semiconductor element based on deviations between respective stored results of the calibration procedures.

16. The method according to claim 14, wherein the calibration procedure:
(i) provides ascertaining a temperature coefficient for the semiconductor component based on at least two measurements which differ from one another in term of time, and/or
(ii) provides ascertaining a temperature dependence of the gate driver; and
wherein the temperature coefficient and/or information about the temperature dependence of the gate driver are taken into account when ascertaining the junction temperature.

17. The method according to claim 11, wherein ascertaining the junction temperature is carried out:
(i) during a switching-on process and/or a switching-off process of the semiconductor component, and/or
(ii) in a switched-on and/or a switched-off state of the semiconductor component, wherein a predefined pulse-shaped alternating signal, is generated by the gate driver at the gate of the semiconductor component.

18. The method according to claim 11, wherein, when ascertaining the junction temperature, an influence of an amount of charge that is recharged during the current build-up phase with respect to the input capacitance of the semiconductor component is taken into account as well.

19. A circuit arrangement for ascertaining a junction temperature of a semiconductor component, comprising:
a semiconductor component including an insulated gate;
a current-controlled gate driver;
a voltage measuring unit; and
an evaluation unit;
wherein
the current-controlled gate driver is configured to recharge an input capacitance of the semiconductor component at a first predefined time via an actuation of the gate of the semiconductor component,
the voltage measuring unit is configured to acquire an external gate voltage of the semiconductor component, and
the evaluation unit is configured to ascertain a junction temperature of the semiconductor component based on information about a voltage-dependent behavior of the input capacitance of the semiconductor component and based on a level of an internal gate resistor of the semiconductor component at a second time which follows the first time, the second time being a time at which a current build-up phase of a gate current generated by the gate driver for recharging the input capacitance has ended and at which a substantially constant gate current present.

20. The circuit arrangement according to claim 19, wherein the internal gate resistor of the semiconductor component includes a bidirectionally conductive, non-linear component, configured of two diodes connected in antiparallel.
